(19) United States
(12) Patent Application Publication
(10) Pub. No.: US 2008/0135066 A1
(43) Pub. Date: Jun. 12, 2008

(54) Method For Cleaning a Vacuum Screw-Type Pump

(76) Inventors: Christian Beyer, Koln (DE); Olaf Stahlschmidt, Koln (DE); Uwe Tollig, Koln (DE)

Correspondence Address: FAY SHARPE LLP, 1100 SUPERIOR AVENUE, SEVENTH FLOOR, CLEVELAND, OH, 44114, US

(21) Appl. No.: 11/793,631

(22) PCT Filed: Dec. 5, 2005
(86) PCT No.: PCT/EP05/56489

§ 371 Date: Jun. 20, 2007

(30) Foreign Application Priority Data
Dec. 22, 2004 (DE) 10-2004-063.058.5

(51) Int. Cl. B08B 9/035

(52) U.S. Cl. 134/21; 134/169 R

(57) ABSTRACT

A method for cleaning a dry compressing screw-type vacuum pump with internal compression includes the following method steps:
operating the screw-type pump (12) at nominal rotation speed,
mixing a cleaning fluid composed of a rinsing liquid and a rinsing gas at a volume ratio of at least 1:10, and
introducing the cleaning fluid into the gas inlet (16) of the screw-type pump (12).

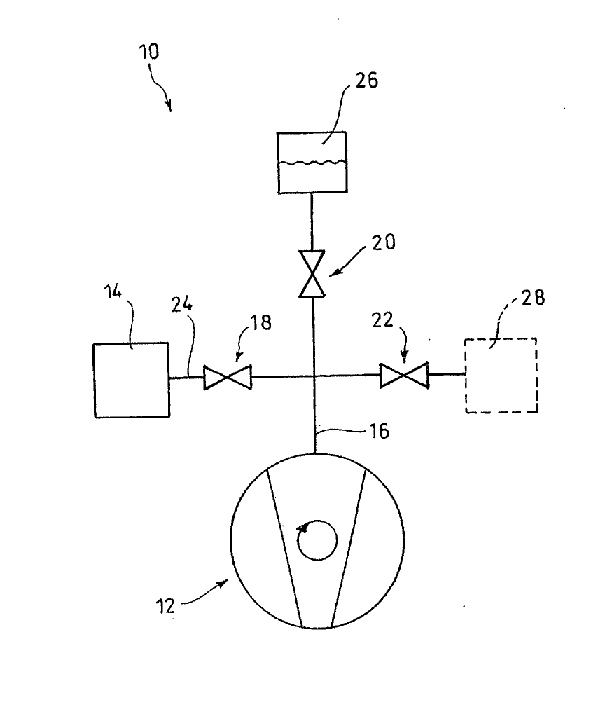

The cleaning method allows a dry compressing screw-type vacuum pump with internal compression to be cleaned in a simple manner at regular intervals.

### BACKGROUND

The invention relates to a method for cleaning a dry compressing screw-type vacuum pump with internal compression.

Dry compressing screw-type vacuum pumps with internal compression, i.e. with non-isochoric compression, are operated without any lubricating, sealing and cleaning liquid. During certain vacuum processes involving a large amount of condensate and high stress, e.g. sintering or soldering processes, deposits may accumulate at the pump rotors and/or the pumping chamber housing. Thus, the friction between the pump rotors and the pumping chamber housing increases such that the screw-type pump is finally difficult to start or cannot be started at all, considerable vibrations may occur during operation and/or a complete breakdown of the screw-type pump may occur. Therefore, the dry compressing screw-type pump is cleaned at regular intervals.

Manual cleaning is time-consuming and labor-intensive since this requires the pumping chamber housing to be opened.

It is an object of the invention to provide a simple method for cleaning a dry compressing screw-type vacuum pump with internal compression.

### SUMMARY

The method according to the invention includes the following method steps:
operating the screw-type pump at nominal rotation speed,
mixing a cleaning fluid composed of a rinsing liquid and a rinsing gas at a volume ratio of at least 1:10, and
introducing the cleaning fluid into the gas inlet of the screw-type pump.

The cleaning fluid is introduced through the main gas inlet of the screw-type pump, said inlet also being used for evacuation purposes. A separate inlet for introducing the cleaning fluid is not required. During the cleaning process, the screw-type pump is operated at its nominal rotation speed. It is not necessary to reduce the rotation speed when cleaning the pump. In this manner, the technical expenditure with regard to rotation speed reduction, which may be considerable depending on the type of the electric drive motor used, is omitted.

To one volume share of rinsing liquid at least ten volume shares of rinsing gas, related to an atmospheric gas pressure of the rinsing gas, are allotted. By providing a considerable amount of rinsing gas in the cleaning fluid, the screw-type pump with internal compression can be rinsed at nominal rotation speed without any rotation speed reduction. The rinsing gas in the cleaning fluid ensures a moderate pressure increase in the pumping chambers of the screw-type pump.

The rinsing gas comes from another source than the vacuum gas. The rinsing gas is not the gas pumped out of a vacuum chamber for generating a vacuum. During the cleaning process, no evacuation takes place.

The cleaning method allows for rapid and inexpensive cleaning of the screw-type pump at regular intervals without the need for dismantling the pump.

Preferably, the cleaning fluid is mixed at a rinsing liquid-to-rinsing gas volume ratio of at least 1:100, preferably at least 1:1000.

According to a preferred embodiment, the cleaning fluid is mixed with water as the rinsing liquid. Distilled water may be used, however tap water may also be employed depending on the application. In any case, water as rinsing liquid is inexpensive and nearly everywhere at hand.

Preferably, the cleaning fluid is mixed with air as the rinsing gas. In most cases, ambient air may be used for this purpose. Thus the rinsing gas can be virtually obtained everywhere in a simple and inexpensive manner.

According to a preferred embodiment, the rinsing gas has a pressure of at least 500 mbar and may have approximately atmospheric pressure. The slightly throttled or unthrottled ambient air may thus be used for mixing the cleaning fluid.

Preferably, nitrogen and/or argon may be used as rinsing gas. Nitrogen and argon are relatively unaggressive and are thus suitable as rinsing gas in particularly sensitive applications and/or environments.

Preferably, a gas ballast valve of the screw-type pump is opened during the cleaning process. This allows the cleaned parts of the screw-type pump, in particular the shaft sealings, to dry more rapidly.

According to a preferred embodiment, the vacuum line extending to the gas inlet is closed prior to introduction of the cleaning fluid, and the vacuum line is opened again after termination of the cleaning fluid introduction. In this manner, ingress of the cleaning fluid into the vacuum line and/or the connected vacuum chamber is reliably prevented.

### BRIEF DESCRIPTION OF THE DRAWINGS

An embodiment of the invention will now be described in greater detail with reference to the FIGURE, which is for illustrative purposes only and are not to be taken as limiting the invention.

The FIGURE schematically shows the configuration of a plant comprising a screw-type vacuum pump for performing the cleaning process according to the invention.

### DETAILED DESCRIPTION

The FIGURE shows a vacuum assembly 10 serving for evacuating a vacuum chamber 14. The vacuum chamber 14 may be part of a sintering plant, a plasma CVD plant or any other plant where the gas pumped out by the screw-type pump 12 contains constituents which may deposit in the screw-type pump 12.

The screw-type pump 12 comprises a gas inlet 16 which is connected via interposed valves 18,20,22 to the vacuum chamber 14, a rinsing liquid container 26 and a rinsing gas container 28, if necessary.

During the pumping operation, the screw-type pump 12 rotates at a rotation speed of 8000 rpm, for example. During the pumping operation, the vacuum valve 18 is open, whereas the other two valves 20,22 are closed. During the pumping operation, the vacuum chamber 14 is evacuated in this manner.

The screw-type pump 12 is cleaned and/or rinsed at regular intervals after a predetermined operation period.

For rinsing the screw-type pump 12, first the vacuum valve 18 is closed such that the evacuating operation is interrupted. Subsequently, the rinsing gas valve 22 is opened such that the rinsing gas, for example ambient air, is taken in by the screw-type pump 12. Nitrogen or argon may also be used as rinsing gas which is stored in a suitable rinsing gas container 28.

Subsequently, the rinsing liquid valve 20 is opened such that the rinsing liquid is taken in by the screw-type pump 12. Tap water is used as rinsing liquid, however other liquids are also suitable. The rinsing gas and the rinsing liquid are mixed upstream of the gas inlet 16 of the screw-type pump 12 to form a cleaning fluid composed of approximately 0.2-3.0 l/min. rinsing liquid and approximately 4000-8000 standard liters/min. rinsing gas. In the present case, approximately 1.0 liter per minute rinsing liquid is mixed with the rinsing gas.

Via the rinsing gas valve 22 the rinsing gas is fed into the screw-type pump 12 approximately at atmospheric pressure, but at least at approximately 500 mbar.

The total consumption of cleaning fluid and the duration of the cleaning process depend on the degree of contamination of the screw-type pump 12. The cleaning process can be terminated when the color of the rinsing liquid leaving the screw-type pump 12 is clear, and the rinsing liquid is no longer colored. According to experience, the cleaning process requires from 3.0 to 8.0 liters rinsing liquid such that the cleaning process takes only a few minutes. After termination of the actual cleaning process, the rinsing gas valve 22 remains open for another few minutes such that the interior of the screw-type pump 12 is allowed to dry as rapidly as possible.

Tests have shown that 20-30 seconds after opening of the rinsing liquid valve 20 a vapor stream leaves the outlet of the screw-type pump 12 for a period of 2-3 seconds. This phenomenon is due to the fact that the gaps in the screw-type pump 12 between the screw-type rotors and/or between the screw-type rotors and the housing are sealed by the entering liquid, whereby the suction capacity considerably increases. The strong compression of the rinsing gas results in a rapid and strong heating such that the rinsing liquid in the pumping chamber evaporates. The water vapor is discharged through the gas outlet of the screw-type pump 12, and the gaps are again relatively inadequately sealed. The described cycle now starts anew.

Following the actual cleaning process, the rinsing gas valve 22 remains open for a period of 5-10 minutes to allow for an accelerated drying of the interior of the screw-type pump 12. During and/or after the cleaning process, a gas ballast valve, if present, of the screw-type pump 12 is opened. This allows for an accelerated drying after the actual cleaning process.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method for cleaning a dry compressing screw-type vacuum pump with internal compression, comprising the following method steps:
operating the screw-type pump at nominal rotation speed,
mixing a cleaning fluid composed of a rinsing liquid and a rinsing gas at a volume ratio of at least 1:10, and
introducing the cleaning fluid into the gas inlet of the screw-type pump.

2. The method according to claim 1, wherein the rinsing gas comes from another source than the vacuum gas.

3. The method according to claim 1, wherein the cleaning fluid is mixed at a volume ratio of at least 1:100, preferably at least 1:1000.

4. The method according to claim 1, wherein the cleaning fluid is mixed with water as the rinsing liquid.

5. The method according to claim 1, wherein the cleaning fluid is mixed with air as the rinsing gas.

6. The method according to claim 1, wherein the rinsing gas has a pressure of at least 500 mbar.

7. The method according to claim 6, wherein the rinsing gas has approximately atmospheric pressure.

8. The method according to claim 1, wherein the rinsing gas is at least one of nitrogen and argon.

9. The method according to claim 1, wherein during the cleaning process a gas ballast valve of the screw-type pump is open.

10. The method according to claim 1, further including the following method steps:
prior to introduction of the cleaning fluid: closing the vacuum line extending to the gas inlet of the vacuum pump, and
after termination of introduction of the cleaning fluid: opening the vacuum line.

11. An apparatus for cleaning a dry compressing screw-type vacuum pump with internal compression, comprising means for:
operating the screw-type pump at nominal rotation speed,
mixing a cleaning fluid composed of a rinsing liquid and a rinsing gas at a volume ratio of at least 1:10, and
introducing the cleaning fluid into the gas inlet of the screw-type pump.
